(19) United States
(12) Patent Application Publication
(10) Pub. No.: US 2019/0146946 A1
(43) Pub. Date: May 16, 2019

(54) METHOD AND DEVICE FOR ARCHIVING BLOCK DATA OF BLOCKCHAIN AND METHOD AND DEVICE FOR QUERYING THE SAME

(71) Applicant: ZhongAn Information Technology Service Co., Ltd., Shenzhen (CN)

(72) Inventor: Le ZHANG, Shenzhen (CN)

(21) Appl. No.: 16/243,835

(22) Filed: Jan. 9, 2019

Related U.S. Application Data
(63) Continuation of application No. PCT/CN2018/095783, filed on Jul. 16, 2018.

(30) Foreign Application Priority Data
Aug. 2, 2017 (CN) 201710651103.8

(51) Int. Cl. G06F 16/11; G06F 16/174; G06F 16/13; G06F 16/14; G06F 16/215; G06F 16/21

(52) U.S. Cl. CPC G06F 16/113; G06F 16/1744; G06F 16/219; G06F 16/148; G06F 16/215; G06F 16/137

(57) ABSTRACT

The present invention discloses a method and a device for archiving block data of blockchain and a method and a device for querying block data of blockchain, which realize archiving of the block data that rarely used. Wherein the archiving method includes: detecting whether there is a block data which satisfies an archiving condition in a node of a blockchain; when the block data is detected, locally copying the block data, compressing the block data to generate a compressed package file, and uploading the compressed package file to a reliable distributed storage system; and when the compressed package file is successfully uploaded, acquiring a hash value of the compressed package file, and inserting the hash value and a height range of the blocks in the compressed package file into an archived file hash table.

### CROSS-REFERENCE TO ASSOCIATED APPLICATIONS

This application is a continuation application of International Application No. PCT/CN2018/095783, filed on Jul. 16, 2018 which claims priority to Chinese patent application No. 201710651103.8, filed on Aug. 2, 2017. Both of the applications are hereby incorporated by reference in their entireties.

### TECHNICAL FIELD

Embodiments of the present invention relate to the field of computer technologies, in particular, a method and a device for archiving block data of a blockchain, and a method and a device for querying the same.

### BACKGROUND

Blockchain is a distributed ledger that can generate and update data by distributed node consensus algorithm, and resistant to modification of the recorded data, it use cryptography to ensure the security of data transmission and access, and establish a data network with mutual trust.

Data archiving is a method to keep the size of an online database almost unchanged but to provide stable database performance for user applications. The working principle of the data archiving is migrating data that has not been used for a long time in online databases to historical databases or file formats store reduces the size of active data.

Since archived data may be backed up at any time without affecting the application of the online database, this part of the data is generally long time inactive; the online database is also slimmed down after the data archiving, the amount of backup data is reduced. And when the data is synchronized and restored, recovery of the online database may be completed firstly in a short time, and then recovery work of other data may be performed, which can improve the efficiency and availability.

Since each node in the blockchain stores complete data, with the increase of a chain height, the data of each node is increased all the time, and therefore the data of the blockchain needs to be archived. At present, there is no efficient method of the data archiving for block data in the node of the blockchain. After research, the data stored in the blockchain is mainly divided into state data and block data. Access probability of the block data is low, data volume of the block data is large, and the block data cannot be changed. Therefore, it is necessary to provide a method for the data archiving of the block data of the blockchain.

### SUMMARY

In view of this, embodiments of the present invention provide a method and a device for archiving block data of a blockchain and a method and a device for querying block data of a blockchain, so as to reduce space occupation of the block data on a disk, and improve the backup efficiency and recovery efficiency of the block data in a node.

According to a first aspect of the embodiments of the present invention, the method for archiving block data of blockchain is provided, the method includes: detecting whether there is a block data which satisfies an archiving condition in a node of a blockchain, wherein the archiving condition comprises a height value of the block data and an access frequency of the block data; when the block data which satisfies the archiving condition is detected, locally copying the block data which satisfies the archiving condition, compressing the block data to generate a compressed package file, and uploading the compressed package file to a reliable distributed storage system; when the compressed package file is successfully uploaded to the reliable distributed storage system, acquiring a hash value of the compressed package file, and inserting the hash value of the compressed package file and a height range of the blocks in the compressed package into an archive file hash table.

In one embodiment, wherein detecting whether there is the block data which satisfies the archiving condition in the node of the blockchain includes: checking number of the blocks locally stored in the node of the blockchain; when the number of the block data locally stored is larger than a preset number, acquiring the preset number of the blocks from the block data with the lowest height value; and when the access frequency of each of the preset number of the blocks is less than a preset access frequency, determining that the preset number of the blocks are the blocks which satisfy the archiving condition.

In one embodiment, wherein when the access frequency of each of the preset number of the blocks is less than the preset access frequency, determining that the preset number of the blocks are the blocks which satisfy the archiving condition includes: recording the blocks, the access frequency of which is higher than the preset access frequency in a preset period, and the corresponding height value; matching the height values of the preset number of the blocks with the height values of the blocks, the access frequency of which is higher than the preset access frequency; when none of the height values of the preset number of the blocks matches the height value of the blocks, the access frequency of which is higher than the preset access frequency, determining that the preset number of the block data are the blocks which satisfy the archiving condition.

In one embodiment, wherein detecting whether there is the block data which satisfies the archiving condition in the node of the blockchain includes: periodically detecting whether there is the block data which satisfies the archiving condition in the node of the blockchain, wherein a period of the detecting step is less than a time for generating the preset number of the blocks.

In one embodiment, wherein the method further includes: maintaining, in a database of the node of the blockchain, the archived file hash table, wherein the archived file hash table is adapted to save a corresponding relationship between a hash value of the archived compressed package file in the node of the blockchain and the height range of the blocks in the compressed package file.

In one embodiment, wherein the method also includes: when the compressed package file is not successfully uploaded to the reliable distributed storage system, outputting an error log and re-uploading the compressed package file to the reliable distributed storage system; when the compressed package file is failed in re-uploading to the reliable distributed storage system, returning to the step that detecting whether there is the block data which satisfies the archiving condition in the node of the blockchain; and deleting redundant data generated.

According to a second aspect of the embodiments of the present invention, a method for querying block data of a blockchain is provided, the method for querying includes: acquiring a query request, wherein the query request includes a height value of a block data to be queried; when the block data to be queried is an archived block data, querying, in an archived file hash table, a hash value of a compressed package file corresponding to the height value, according to the height value, wherein the archived file hash table includes a corresponding relationship between the hash value of the compressed package file of the archive block data and a height range of the blocks in the compressed package file; when the hash value of the compressed package file corresponding to the height value is queried, determining, under a locally downloaded historical data directory, whether there is a folder named with the hash value; when the folder named with the hash value is queried, accessing, under the historical data directory, the block data under the folder named with the hash value for querying; when the folder named with the hash value is not queried, downloading the compressed package file corresponding to the hash value from a reliable distributed storage system, decompressing the compressed package file, and returning a query result.

In one embodiment, wherein when the hash value of the compressed package file corresponding to the height value is not queried, the query request is forwarded to other nodes.

In one embodiment, wherein after the query request is acquired, the method further includes: determining, according to whether the height value is less than the lowest height value of the blocks stored locally in the node of the blockchain, whether the block data to be queried has been archived.

According to a third aspect of the embodiments of the present invention, a device for archiving block data of a blockchain is provided. the archiving device includes a memory and a processor, wherein, when the processor executes the following steps: detecting whether there is a block data which satisfies an archiving condition in a node of a blockchain, wherein the archiving condition comprises a height value of the block data and an access frequency of the block data; when the block data which satisfies the archiving condition is detected, locally copying the block data which satisfies the archiving condition, compressing the block data to generate a compressed package file, and uploading the compressed package file to a reliable distributed storage system; when the compressed package file is successfully uploaded to the reliable distributed storage system, acquiring a hash value of the compressed package file, and inserting the hash value of the compressed package file and a record of a height range of the blocks in the compressed package file into an archived file hash table.

In one embodiment, wherein when executing the step of detecting whether there is the block data which satisfies the archiving condition in the node of the blockchain, the processor specifically executes the following steps: checking a number of the blocks locally stored in the node of the blockchain; when the number of the blocks locally stored is larger than a preset number, acquiring the preset number of the blocks from the block data with the lowest height value; and when the access frequency of each of the preset number of the blocks is less than a preset access frequency, determining that the preset number of the blocks are the blocks which satisfy the archiving condition.

In one embodiment, wherein when executing the step of when the access frequency of each of the preset number of the blocks is less than the preset access frequency, determining that the preset number of the blocks are the blocks which satisfy the archiving condition, the processor specifically executes the following steps: recording the block data, the access frequency of which is higher than the preset access frequency in a preset period, and the corresponding height value ; matching the height values of the preset number of the blocks with the height value of the block data, the access frequency of which is higher than the preset access frequency; when none of the height values of the preset number of the blocks matches the height value of the block data, the access frequency of which is higher than the preset access frequency, determining that the preset number of the blocks are the blocks which satisfy the archiving condition.

In one embodiment, wherein when executing the step of detecting whether there is the block data which satisfies the archiving condition in the node of the blockchain, the processor specifically executes the following steps: periodically detecting whether there is the block data which satisfies the archiving condition in the node of the blockchain, wherein a period of the detecting step is less than a time for generating the preset number of the blocks.

In one embodiment, wherein the processor further executes the following step: maintaining, in a database of the node of the blockchain, the archived file hash table, wherein the archived file hash table is adapted to save a corresponding relationship between the hash value of the archived compressed package file in the node of the blockchain and the height range of the blocks in the compressed package file.

In one embodiment, wherein the processor further executes the following steps: when the compressed package file is not successfully uploaded to the reliable distributed storage system, outputting an error log and re-uploading the compressed package file to the reliable distributed storage system; when the compressed package file is not successfully re-uploaded to the reliable distributed storage system, returning to the step that detecting whether there is the block data which satisfies the archiving condition in the node of the blockchain; and deleting redundant data generated.

According to a forth aspect of the embodiments of the present invention, a device for querying block data of a blockchain is provided, comprising a memory and a processor, wherein, the processor executes the following steps: acquiring a query request, wherein the query request comprises a height value of a block data to be queried; when the block data to be queried is an archived block data, querying, in an archived file hash table, a hash value of a compressed package file corresponding to the height value, according to the height value, wherein the archived file hash table comprises a corresponding relationship between the hash value of the compressed package file of the archived block data and a height range of the blocks in the compressed package file; when the hash value of the compressed package file corresponding to the height value is queried, determining, under a locally downloaded historical data directory, whether there is a folder named with the same hash value; when the folder named with the same hash value is queried, accessing, under the historical data directory, the block data under the folder named with the same hash value for querying; when the folder named with the same hash value is not queried, downloading the compressed package file corresponding to the hash value from a reliable distributed storage system, decompressing the compressed package file, and returning a query result.

In one embodiment, wherein when the hash value of the compressed package file corresponding to the height value is not queried, the query request is forwarded to other nodes.

In one embodiment, wherein after the query request is acquired, wherein the processor further executes the following step: determining, according to whether the height value is less than the lowest height value of the blocks stored locally in the node of the blockchain, whether the block data to be queried has been archived.

The method and device for archiving the block data of the blockchain and the method and device for querying the block data of the blockchain, provided in accordance with the embodiment of the present invention, can be easily and efficiently divided the block data which is rarely used, by setting the height value of the block data and the access frequency of the block data as the archiving condition; ensure the security of archived data and prevent the archived data from being modified, by uploading the compressed package file of the block data, which is rarely used, to the reliable distributed storage system; and realize the archived data and facilitate to recover the query of the archived data, by inserting the hash value of the compressed package file and the record of the height range of the blocks of the compressed package file into the archive file hash table.

### BRIEF DESCRIPTION OF DRAWINGS

FIG. 1 is a flowchart of a method for archiving block data of a blockchain according to a first embodiment of the present invention.

FIG. 2 is a flowchart of a method for archiving block data of a blockchain according to a second embodiment of the present invention.

FIG. 3 is a flowchart of a method for querying block data of a blockchain according to a third embodiment of the present invention.

FIG. 4 is a flowchart of a method for querying block data of blockchain according to a forth embodiment of the present invention.

FIG. 5 is a structural block diagram of a device for archiving block data of a blockchain according to an embodiment of the present invention.

FIG. 6 is a structural block diagram of a device for querying block data of a blockchain according to an embodiment of the present invention.

FIG. 7 is a structural block diagram of an electronic device according to an embodiment of the present invention.

FIG. 8 is a structural block diagram of a computer device according to an embodiment of the present invention.

### DETAILED DESCRIPTION OF EMBODIMENTS

In order to more clearly illustrate the purpose, technical solution and advantages of the present invention, hereinafter, the present invention will be described in more detail with reference to the appended drawings.

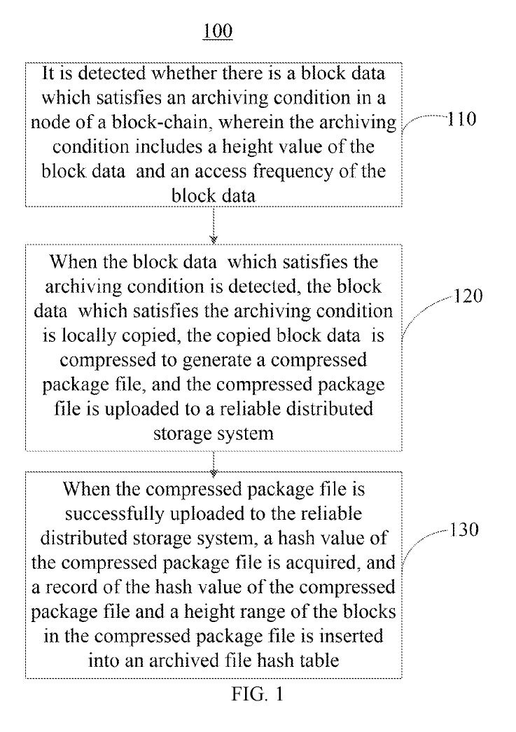

FIG. 1 is a flowchart of a method for archiving block data of a blockchain according to a first embodiment of the present invention. The method may be performed by a node or a network device, both of which are based on a blockchain, as can be seen in the figure, the method 100 includes following steps:

110. It is detected whether there is a block data which satisfies an archiving condition in a node of a blockchain, wherein the archiving condition includes a height value of the block data and an access frequency of the block data.

The blockchain is a technique for implementing a centerless distributed ledger, each block data that makes up the blockchain is similar to a page of a ledger, a number of transactions are recorded on each page, and a complete ledger, i.e. the blockchain, is formed by binding the pages of the ledger one by one in chronological order. The height value of the block data and the access frequency of the block data can intuitively reflect whether the block data in the node of the blockchain is long-term unused data.

120. When the block data which satisfies the archiving condition is detected, the block data which satisfies the archiving condition is locally copied, the copied block data is compressed to generate a compressed package file, and the compressed package file is uploaded to a reliable distributed storage system.

The reliable distributed storage system is a reliable distributed storage system with characteristics of non-modification, non-missing, public traceability and natural disaster tolerance.

130. When the compressed package file is successfully uploaded to the reliable distributed storage system, a hash value of the compressed package file is acquired, and the hash value of the compressed package file and a height range of the blocks in the compressed package file is inserted into an archived file hash table.

According to the method for archiving the block data of the blockchain provided by the embodiment of the present invention, the block data, which is rarely used, can be easily and efficiently divided out by setting the height value and the access frequency of the block data as the archiving condition; the security of the archived data is ensured by uploading the compressed package file of the block data, which is rarely used, to the reliable distributed storage system, and the archived data can be prevented from being tampered with; the record of the archived data is realized by inserting the hash value of the compressed package file and the height range of the blocks in the compressed package file as a record into the archived file hash table, and it is facilitate to recover and query the archived data.

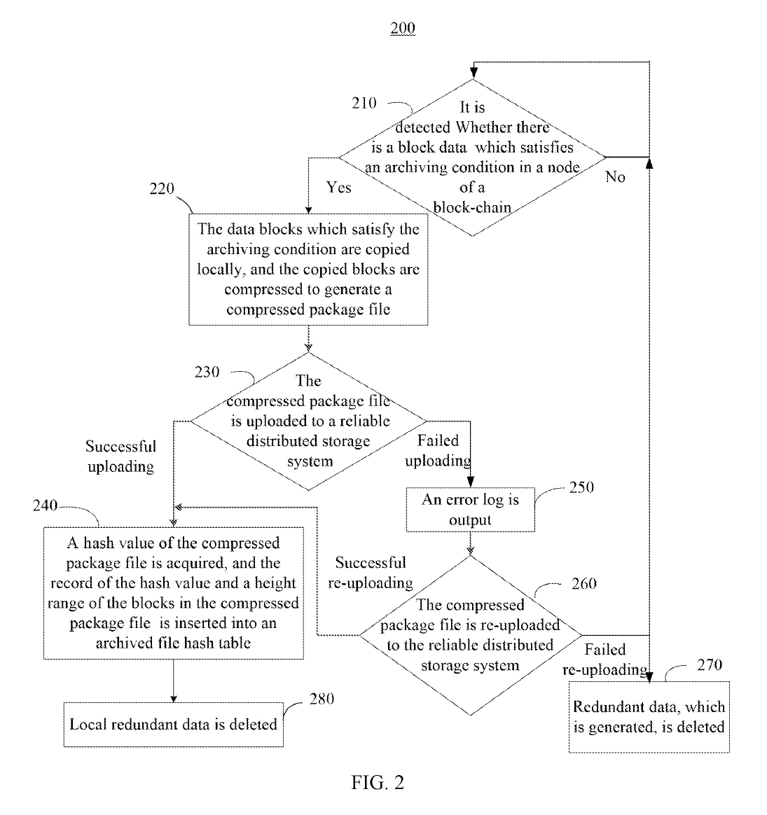

FIG. 2 is a flowchart of a method for archiving block data of a blockchain according to a second embodiment of the present invention. As can be seen in the FIG. 2, the method 200 includes:

210. It is detected whether there is a block data which satisfies an archiving condition in a node of a blockchain, when the block data which satisfies the archiving condition in the node of the blockchain is detected, performing step 220, and when the block data which satisfies the archiving condition in the node of the blockchain is not detected, performing the step 210 repeatedly.

Wherein, the archiving condition includes whether the height value of the block data is less than a preset height value and whether the access frequency of the block data is less than a preset access frequency, the preset height value depends on number of the blocks locally stored in the node of the blockchain, the lowest height value of the blocks locally stored, and a preset number.

Specifically, in one embodiment, the process of detecting whether there is a block data which satisfies a archiving condition in a node of a blockchain includes:

a. The number of the blocks locally stored in the node of the blockchain, i.e., the number of all the blocks between the block data with the lowest height value and the block data with the highest height value, is checked.

For example, the lowest height value of the blocks locally stored is HO, and the highest height value of the blocks locally stored is H11, and then the number of the blocks locally stored is H11−H0+1=11, i.e., there are eleven blocks between the lowest height value and the highest height value.

b. When the number of the blocks locally stored is larger than a preset number, the preset number of the blocks are acquired, which is started from the block data with the lowest height value.

The preset number may be M, the specific value of the preset number is not limited by the embodiment of the present invention, and may be configured according to the actual application environment. For example, M is 10, the specific embodiment in step a is still taken as an example, When the number of the blocks between the lowest height value and the highest height value which are locally stored is larger than the preset number, i.e., 11 is more than 10, and then the preset number of the blocks, i.e., the blocks from H0 to H10, are acquired, which is started from the block data with the lowest height value.

c. When the access frequency of each of the preset number of the blocks is less than the preset access frequency, the preset number of the blocks is determined to be the blocks which satisfy the archiving condition.

For example, a list is maintained in a memory, to record the blocks, the access frequency of which are higher than the preset access frequency in a preset period and the height values corresponding to the blocks, the preset access frequency is N, and the blocks, the access frequency of which is higher than N, are recorded, such as {T1 . . . T10}.

In this case, when all the preset number of the blocks, i.e., the blocks from H0 to H10, are not in {T1 . . . T10}, the blocks from H0 to H10 are determined to be the blocks which satisfy the archiving condition, i.e., the access frequency of each of the preset number of the blocks is less than the preset access frequency, and the preset number of the blocks are determined to satisfy the archiving condition.

It should be noted that the specific value of the preset access frequency is not limited by the embodiment of the present invention, and may be specifically set according to the actual application.

220. The blocks which satisfy the archiving condition are copied locally, and the copied blocks are compressed to generate a compressed package file.

For example, the blocks, which satisfy the archiving condition, are copies from a local blockstore.db database, and are compressed to generate the compressed package file.

In one embodiment, the blocks which satisfy the archiving condition are copied locally in 220 further includes: A specific path is set; and the blocks which satisfy the archiving condition are copied locally through the specific path which is set.

230. The compressed package file is uploaded to a reliable distributed storage system, when the compressed package file is successfully uploaded to the reliable distributed storage system, performing step 240; and when the compressed package file is not successfully uploaded to the reliable distributed storage system, performing steps 250 to 270.

240. A hash value of the compressed package file, which is uploaded, is acquired, and the record of the hash value of the compressed package file and a height range of the blocks in the compressed package file uploaded is inserted into an archived file hash table.

For example, a key-value storage method is adopted in the archived file hash table, wherein the height value range of the blocks is used as the key, and the hash value of the compressed package file uploaded is used as the value, so that the record is formed. Exemplarily, the record such as 1_1000: filehash0, which indicates that the hash value, corresponding to the compressed package file of the blocks of height 1 to 1000, is filehash0.

Optionally, after the record of the hash value of the compressed package file and the height range of the blocks of the compressed package file is inserted into the archived file hash table, i.e., after step 240, the method 200 further includes: 280. Local redundant data is deleted.

Specifically, after the compressed package file is successfully uploaded to the reliable distributed storage system, and the record of the hash value of the compressed package file and the height range of the blocks of the compressed package file are inserted into the archived file hash table, i.e., after the step 240, a local compressed package file and the redundant data of locally archived blocks are deleted, which avoids accumulation of the redundant data and disk occupation.

250. An error log is output.

260. The compressed package file is re-uploaded to the reliable distributed storage system, when the compressed package file is successfully re-uploaded to the reliable distributed storage system, performing the step 240; and when the compressed package file is failed in re-uploading to the reliable distributed storage system, returning to the step 210, and performing step 270.

Specifically, the error is corrected according to feedback of the output error log, and the compressed package file is repeatedly packaged and uploaded in each preset period until the compressed package file is uploaded successfully.

270. Redundant data, which is generated, is deleted.

Specifically, the redundant data, such as the compressed package file that has not been successfully uploaded, is deleted.

It should be noted that steps 260 to 270 is re-uploading process, and the re-uploading process may be implemented by other methods in addition to the above-mentioned method, and the re-uploading process is not limited by the embodiments of the present invention.

According to the method for archiving the block data of the blockchain provided by any one of the above-mentioned embodiments of the present invention, the block data which is rarely used can be easily and efficiently divided out by setting the height value of the block data and the access frequency of the block data as the archiving condition; the security of archived data is ensured by uploading the compressed package file of the block data, which is rarely used, to the reliable distributed storage system, and the archived data can be prevented from being tampered; and the record of the archived data is realized by inserting the record of the hash value of the compressed package file and the height range of the blocks of the compressed package file into the archived file hash table, and it is facilitate to recover and query the archived data.

In one embodiment, the step 210 specifically includes: It is detected whether there is the block data which satisfies the archiving condition in the node of the blockchain periodically. Detecting the block data, in the node of the blockchain, which satisfies the archiving condition periodically to archive this part of data, which can reduce scale of active data, the number of the data archived each time can be reduced at the same time, and the efficiency of data backup and data recovery can be improved.

In this case, the method 200 may further include: A time for periodic detection is set. Specifically, the time for periodic detection is less than the time in which the preset number of the blocks is generated.

Wherein, the periodic detection may be real-time detection, and the time for the periodic detection is set according to the actual application, which is not limited by the embodiments of the present invention.

The detect period is set less than the time in which the preset number of the blocks are generated, which ensures that the preset number of the blocks, which has already satisfied the archiving condition, can be archived before the preset number of the blocks are generated again, thereby the accumulation of the local blocks can be avoid.

In one embodiment, the method 200 further includes: An archived file hash table is maintained in a database of each of the nodes of the blockchain, and the archived file hash table is configured to persist in saving a corresponding relationship between the hash value of the archived compressed package file in the node of the blockchain and the height range of the archived blocks.

It should be noted that the step may be performed before the step 210, or may be performed before the step 240, or the archived file hash table that is previously maintained may be used in the step 200, which is not limited by the embodiments of the present invention.

In one embodiment, the method 200 further includes: Thermal data is stored in a cache way. The thermal data refers to the block data which may be accessed or be accessed a plurality of times during a certain time in the locally stored blocks.

The access speed can be accelerated and the pressure on device processing can be reduced by caching the thermal data. When the thermal data is not accessed and satisfies the archiving condition, the thermal data is archived

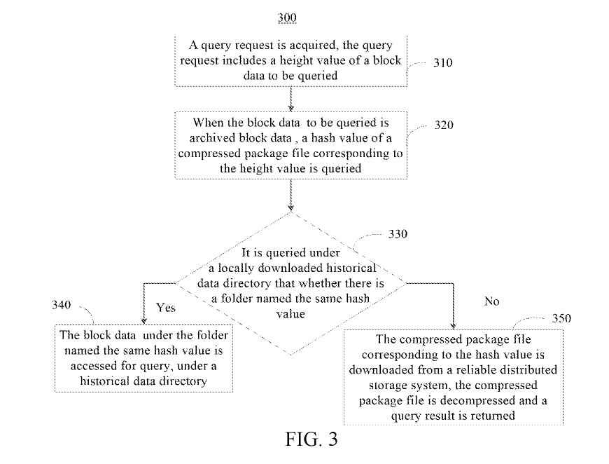

FIG. 3 is a flowchart of a method for querying the block data of a blockchain according to a third embodiment of the present invention. As can be seen in the FIG. 3, the method 300 includes:

310. A query request is acquired, the query request includes a height value of a block data to be queried.

The query request includes the height value of the block data, to be queried, in a node of a blockchain. In other embodiments, the query request may also include other content, and the content of the query request is not limited by the embodiments of the present invention.

320. when the block data to be queried is archived block data, a hash value of a compressed package file corresponding to the height value is queried according to the height value, in an archived file hash table, wherein the archived file hash table includes a corresponding relationship between the hash value of the compressed package file of the archived blocks and a height range of the blocks in the compressed package file.

330. when the hash value of the compressed package file corresponding to the height value is queried, it is determined under a locally downloaded historical data directory that whether there is a folder named with the hash value; When the folder named with the hash value is queried, performing step 340; and when the folder named with the hash value is not queried, performing step 350.

340. The block data under the folder named with the hash value is accessed for query, under a historical data directory.

350. The compressed package file corresponding to the hash value is downloaded from a reliable distributed storage system, the compressed package file is decompressed and a query result is returned.

According to the method for querying the block data of the blockchain provided by the embodiment of the present invention, it is known by default that the block data to be query is archived block data. In this case, the querying is performed in the archived file hash table according to the height value, when the hash value of the compressed package file, corresponding to the height value, can be queried in the archived file hash table, determining, whether there is the folder named with the hash value in the local downloaded historical data directory, is performed, so that the querying can be firstly performed from the local downloaded historical data directory. And when the folder named with the hash value is not queried in the local downloaded historical data directory, then the compressed package file, corresponding to the hash value, is downloaded from a reliable distributed storage system, which avoids problems of waste of processing resource caused by directly downloading from the reliable distributed storage system and accumulation of file such as the compressed package file caused by a plurality of download.

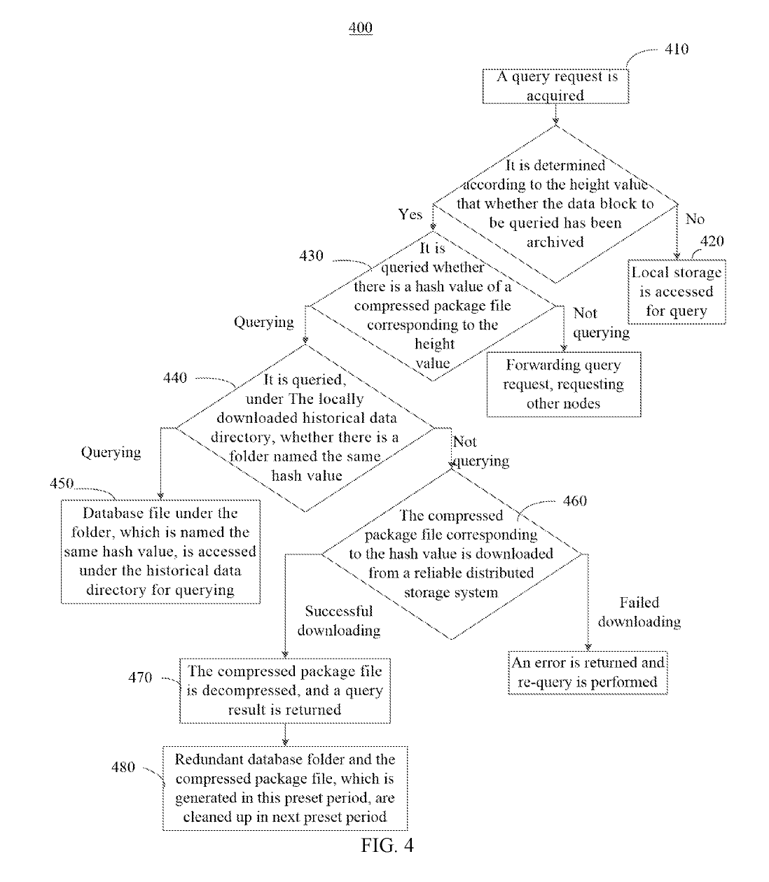

FIG. 4 is a flowchart of a method for querying the block data of a blockchain according to a forth embodiment of the present invention. As may be seen in the FIG. 4, the method 400 includes:

410. A query request is acquired.

Specifically, the query request may be initiated by a client, and a user queries the block data corresponding to a height value by inputting the height value.

420. It is determined according to the height value that whether the block data to be queried has been archived, when the block data to be queried has been archived, performing step 430; and when the block data to be queried has not been archived, local storage is accessed for query.

Specifically, it is determined, according to whether the height value is less than the lowest height value of locally stored blocks in the node of the blockchain, whether the block data to be queried has been archived, When the block data to be queried has been archived, step 430 is performed; and when the block data to be queried has not been archived, local blockstore.db is accessed for query.

Those skilled in the art may understand that, when it has been determined that the block data, to be queried, has been archived before querying, executing process of the step 420 may be omitted, and step 430 is directly performed.

430. It is determined whether there is a hash value of a compressed package file corresponding to the height value, when the hash value of the compressed package file, corresponding to the height value, is queried in the archived file hash table, performing step 440; and when the hash value of the compressed package file, corresponding to the height value, is not queried in the archived file hash table, the query request is forwarded and other nodes are requested.

The archived file hash table includes a record between the hash value of the compressed package file of archived blocks and a height range of the blocks of the compressed package file. For example, a key-value storage method may be adopted in the archived file hash table, wherein the height value range of the blocks is used as the key, and the hash value of uploaded compressed package file is used as the value, so that a record is generated. Exemplarily, the record such as 1_1000: filehash0, which indicates that the hash value, corresponding to the compressed package file of the blocks of height 1 to 1000, is filehash0.

Specifically, when the record, corresponding to the height value, has been queried in the archived file hash table of the node according to the height value, the hash value of the compressed package file corresponding to the height value, in the query request, is calculated by matching algorithm, and step 440 is performed.

When a new node joins cluster, there is a request accessed the node in the process of synchronization of the archived file hash table, since the archived file hash table is not completely synchronized, there is a possibility that the querying of the hash value of the compressed package file, in which the archived block data is located, is failed. So after the archived file hash table is updated, the query request, which carries information of the node, is forwarded, and the query is requested by the other nodes. The querying process is similar to that described in this embodiment, and details are not described herein.

440. It is determined, under the locally downloaded historical data directory, whether there is a folder named with the hash value, when the folder named with the hash value is queried under the locally downloaded historical data directory, performing step 450; and when the folder named with the hash value is not queried under the locally downloaded historical data directory, performing step 460.

Specifically, according to the hash value of the compressed package file obtained by matching calculation, the determining, whether there is the folder named with the hash value as the hash value of the compressed package file under the locally downloaded historical data directory, is performed and when there is the folder named with the hash value as the hash value of the compressed package file, then step 450 is performed; and when there is not the folder named with the hash value as the hash value of the compressed package file, step 460 is performed.

450. Database file under the folder, which is named with the hash value, is accessed under the historical data directory for querying.

460. The compressed package file corresponding to the hash value is downloaded from a reliable distributed storage system. When the compressed package file corresponding to the hash value is successfully downloaded from the reliable distributed storage system, performing step 470; and when the compressed package file corresponding to the hash value is failed in downloading from the reliable distributed storage system, an error is returned and re-query is performed.

The reliable distributed storage system is a reliable distributed storage system with characteristics of non-tampering, non-missing, public traceability and natural disaster tolerance.

470. The compressed package file is decompressed, and a query result is returned.

In one embodiment, after the step 470, the method 400 also includes:

480. Redundant database folder and the compressed package file, which is generated in this preset period, are cleaned up in next preset period.

Specifically, the redundant data, which is generated in this preset period, is cleaned up in the next preset period, and the preset period is set for cleaning up the redundant database folder and the compressed package file which are generated.

The preset period may be the same as or different from the period of periodically detecting the block data which satisfies the archiving condition in the node of the blockchain, which is not limited by the embodiments of the present invention.

According to the method for querying the block data of the blockchain provided by any one of the above embodiments, it is determined, according to the height value in the query request, whether the block data to be queried is archived data, and when the block data to be queried is the archived data, the querying is performed in the archived file hash table according to the height value. When the hash value of the compressed package file, corresponding to the height value, can be queried in the archived file hash table, the determining, whether there is the folder named with the hash value in the local downloaded historical data directory, is performed, so that the querying can be firstly performed from the local downloaded historical data directory, and when the folder named with the hash value is not queried in the local downloaded historical data directory, then the compressed package file, corresponding to the hash value, is downloaded from a reliable distributed storage system, which avoids problems of waste of processing resources caused by directly downloading from the reliable distributed storage system and accumulation of files such as the compressed package file caused by a plurality of downloads. When the hash value of the corresponding compressed package file is not queried in the archived file hash table, the archived file hash table is updated, the query request is forwarded, and the other nodes are requested to query, so as to avoid situation that the hash value of the corresponding compressed package file may not be queried. According to the method for querying the block data of the blockchain provided by any one of the above-mentioned embodiments of the present invention, the archived block data can be query and recover quickly and efficiently, and download operation does not need every time, thereby accumulation of the redundant data can be avoid, the query efficiency and use efficiency of equipment can be improved.

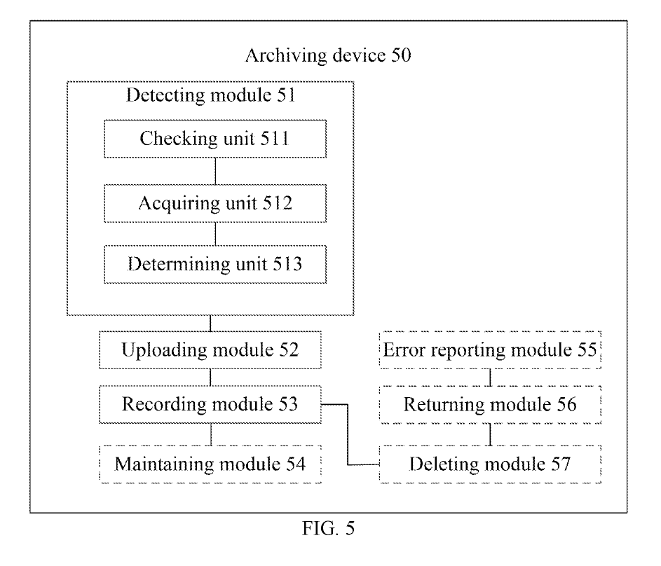

A device for archiving the block data of the blockchain is provided by the embodiment of the present invention. Referring to FIG. 5, the device 50 for archiving includes a detecting module 51, an uploading module 52, and a recording module 53. Wherein, the detecting module 51 is adapted to detect whether there is a block data which satisfies an archiving condition in a node of a blockchain, wherein the archiving condition includes a height value of the block data and an access frequency of the block data. When the detecting module 51 detects the block data which satisfies the archiving condition, the uploading module 52 locally copies the block data which satisfies the archiving condition, compresses the block data to generate a compressed package file, and uploads the compressed package file to a reliable distributed storage system. When the uploading module 52 uploads the compressed package file to the reliable distributed storage system successfully, the recording module 53 acquires a hash value of the compressed package file, and inserts the hash value of the compressed package file and a height range of the blocks of the compressed package file into an archived file hash table.

In one embodiment, the device 50 for archiving further includes: an error reporting module 55, a returning module 56, and a deleting module 57. When the uploading module 52 fails to upload the compressed package file to the reliable distributed storage system, the error reporting module 55 outputs an error log, and the returning module 56 re-uploads the compressed package file, when the compressed package file is successfully re-uploaded, the recording module 53 acquires the hash value of the compressed package file, and inserts the record of the hash value of the compressed package file and the height range of the blocks of the compressed package file into the archived file hash table; When the compressed package file is failed in re-uploading, the detecting module 51 is restarted by the returning module 56, and the detecting module 51 re-detects the block data in the node of the blockchain; and the deleting module 57 deletes redundant data which is generated in this process.

In one embodiment, the detecting module 51 is specifically adapted to periodically detect whether there is the block data which satisfies the archiving condition in the node of the blockchain, wherein a period of the periodic detection is less than a time for generating the preset number of the blocks.

In one embodiment, the detecting module 51 includes: a checking unit 511, which is adapted to check a number of locally stored blocks in the node of the blockchain, i.e., the number of all blocks between the block data with the lowest height value and the block data with the highest height value; an acquiring unit 512, which is adapted to, when the number of the locally stored blocks is greater than a preset number, acquire the preset number of the blocks, which is started from the block data with the lowest height value; and a determining unit 513, which is adapted to, when the access frequency of each of the preset number of the blocks is less than a preset access frequency, determine that the preset number of the blocks are the blocks which satisfy the archiving condition.

In one embodiment, the determining unit 513 is specifically adapted to record, in a preset period, the blocks which access frequency is larger than the preset access frequency and the height values corresponding to the blocks; match the height values of the preset number of the blocks with the height values of the blocks which access frequency is higher than the preset access frequency; and when the height values of the preset number of the blocks do not match the height values of the blocks which access frequency is higher than the preset access frequency, determine that the preset number of the blocks are the blocks which satisfy the archiving condition.

In one embodiment, the archiving device 50 further includes: a maintaining module 54, which is adapted to maintain, in a database of the node of the blockchain, the archived file hash table, wherein the archived file hash table is adapted to save a corresponding relationship between the hash value of archived compressed package file in the node of the blockchain and the height range of the blocks of the compressed package file.

According to the method for archiving the block data of the blockchain provided by the embodiment of the present invention, the block data, which is rarely used, can be easily and efficiently divided out by setting the height value of the blocks and the access frequency of the block data as the archiving condition; the security of archived data is ensured by uploading the compressed package file of the block data, which is rarely used, to the reliable distributed storage system, and the archived data can be prevented from being tampered with; and the archived data is realized by inserting the hash value of the compressed package file and the height range of the blocks of the compressed package file into an archived file hash table, it is facilitate to recover and query the archived data.

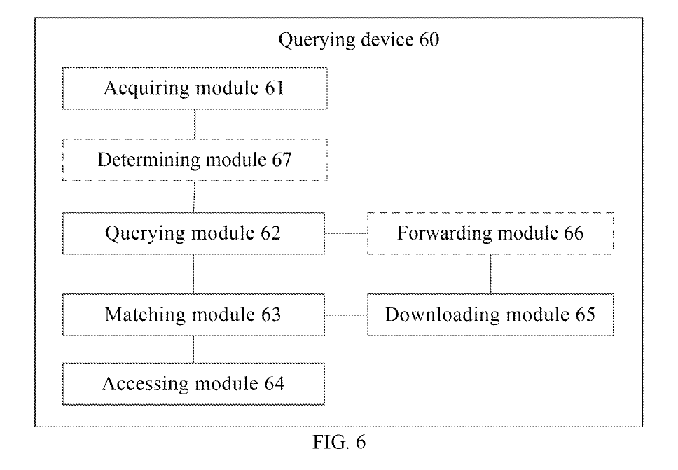

A device for querying the block data of the blockchain is provided by the embodiment of the present invention. Referring to FIG. 6, the querying device 60 includes: an acquiring module 61, a querying module 62, a matching module 63, an accessing module 64, and a downloading module 65. Wherein, the acquiring module 61 is adapted to acquire a query request, the query request includes a height value of a block data to be queried in a node of a blockchain. The querying module 62 is adapted, when the block data to be queried is archived block data, to query a hash value of a compressed package file corresponding to the height value, which is acquired by the acquiring module 61, in an archived file hash table, and the archived file hash table includes a corresponding relationship between the hash value of the compressed package file of the archived block data and a height range of the blocks of the compressed package file. When the hash value of the compressed package file corresponding to the height value is queried by the querying module 62, the matching module 63 determines, under a locally downloaded historical data directory, whether there is a folder named with the hash value. When the folder named with the hash value is queried by the matching module 63, the accessing module 64 is used to access, under the historical data directory, the block data under the folder named with the hash value for querying; and when the folder named with the hash value is not queried by the matching module 63, the downloading module 65 downloads the compressed package file corresponding to the hash value from a reliable distributed storage system, decompresses the compressed package file, and returns a query result.

In one embodiment, the querying device 60 further includes: a forwarding module 66, which is adapted to forward the query request to other nodes, when the hash value of the compressed package file, corresponding to the height value, is not queried by the querying module 62.

In one embodiment, the querying device 60 further includes: a determining module 67, which is adapted, according to whether the height value of the block data to be queried is less than the lowest height value of locally stored blocks in the node of the blockchain, to determine whether the block data to be queried has been archived.

According to the querying device provided by the above embodiment, it is determined, according to the height value in the query request, whether the block data to be queried is archived data, and when the block data to be queried is the archived data, the querying is performed in the archived file hash table according to the height value. When the hash value of the compressed package file, corresponding to the height value, can be queried in the archived file hash table, the determining, whether there is the folder named with the hash value in the local downloaded historical data directory, is performed, so that the querying can be firstly performed in the local downloaded historical data directory, which avoids problems of waste of processing resources caused by directly downloading from a reliable distributed storage system and accumulation of files such as the compressed package file caused by a plurality of downloads. When the hash value of the compressed package file, corresponding to the height value, is not queried in the archived file hash table, the archived file hash table is updated, the query request is forwarded, and the other nodes are requested to query, so as to avoid situation that the hash value of the compressed package file may not be queried. And when the folder named with the hash value is not queried in the local downloaded historical data directory, then the compressed package file, corresponding to the hash value, is downloaded from the reliable distributed storage system, which avoids problem of accumulation of redundant data caused by downloading from the reliable distributed storage system from the beginning, so that according to the method provided by the embodiment of the present invention, archived block data can be quickly and efficiently query and recover, and the archived block data does not need to be downloaded every time, thereby the accumulation of the redundant data can be avoid, and the query efficiency and use efficiency of equipment can be improved.

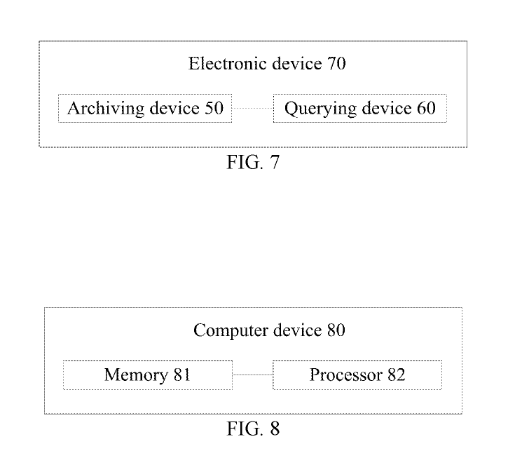

An electronic device is provided by the embodiment of the present invention. Referring to FIG. 7, the electronic device 70 includes the above-mentioned archiving device 50 and querying device 60.

A computer device is provided by the embodiment of the present invention. Referring to FIG. 8, the computer device 80 includes: a memory 81, a processor 82, and a computer program stored on the memory for execution by the processor, wherein, when the computer program is executed by the processor, a method for archiving the block data of the blockchain, provided by any one of the preceding embodiments of the preset invention, is implemented, and/or a method for querying the block data of the blockchain, provided by any one of the preceding embodiments of the preset invention, is implemented.

A computer readable storage medium is further provided by the embodiment of the present invention, and a computer program is stored on the computer readable storage medium. When the computer program is executed by a processor, a method for archiving the block data of the blockchain, provided by any one of the preceding embodiments of the preset invention, is implemented, and/or a method for querying the block data of the blockchain, provided by any one of the preceding embodiments of the preset invention, is implemented. The computer storage medium may be any tangible medium such as a floppy disk, CD-ROM, DVD, hard drive, or even network media.

It should be understood that, although an implementation form of the embodiments of the present invention described above may be a computer program product, the methods or devices of the embodiments of the present invention may be implemented in accordance with software, hardware, or a combination of software and hardware. The hardware portion may be implemented by using dedicated logic; and the software portion may be stored in the memory and system is executed by a suitable instruction execution, such as a microprocessor or dedicated design hardware. A person skilled in the art may understand that the methods and devices described above may be implemented by using executable instructions of the computer and/or embodying in a processor control code, such code is provided, for example, on a carrier medium such as a magnetic disk, CD or DVD-ROM, a programmable memory such as a read only memory (firmware), or a data carrier such as an optical or electronic signal carrier. The methods and devices of the present invention may be implemented by hardware circuits such as very large scale integrated circuits or gate arrays, semiconductors such as logic chips, transistors, or programmable hardware devices such as field programmable gate arrays, programmable logic devices, etc., and may also be implemented by software executed by various types of the processors, or by a combination of the above hardware circuits and software, such as firmware.

It should be noted that, all the preceding optional technical solutions may be adopted in any combination to form an optional embodiment of the present invention, and details are not described herein again.

In addition, when the archiving device and the querying device, provided by the above embodiments, perform respective functions, the division of the above functional modules is only illustrated. In an actual application, the above functions may be completed by allocating to different functional modules as needed, i.e., internal structure of the device is divided into the different functional modules to complete all or part of the above functions described above. In addition, the archiving device, the archiving method, the querying device, and the querying method provided by the preceding embodiments are respectively belong to the same concept, and process of the specific implementation is detailed in the embodiment of the method, and details are not described herein again.

The above embodiments are only preferable embodiments of the present invention, and are not intended to limit the protection scope of the present invention. Any modifications, equivalent substitutions, improvements, etc. made within the spirit and principles of the present invention are intended to be embraced within the protection scope of the present invention.

What is claimed is:

1. A method for archiving block data of a blockchain, comprising:
detecting whether there is a block data which satisfies an archiving condition in a node of a blockchain, wherein the archiving condition comprises a height value of the block data and an access frequency of the block data;
when the block data which satisfies the archiving condition is detected, locally copying the block data which satisfies the archiving condition, compressing the block data to generate a compressed package file, and uploading the compressed package file to a reliable distributed storage system;
when the compressed package file is successfully uploaded to the reliable distributed storage system, acquiring a hash value of the compressed package file, and inserting the hash value of the compressed package file and a record of a height range of the blocks in the compressed package file into an archived file hash table.

2. The method of claim 1, wherein detecting whether there is the block data which satisfies the archiving condition in the node of the blockchain comprises:
checking the number of the blocks locally stored in the node of the blockchain;
when the number of the blocks locally stored is larger than a preset number, acquiring the preset number of the blocks from the block data with the lowest height value; and
when the access frequency of each of the preset number of the blocks is less than a preset access frequency, determining that the preset number of the blocks are the blocks which satisfy the archiving condition.

3. The method of claim 2, wherein when the access frequency of each of the preset number of the blocks is less than the preset access frequency, determining that the preset number of the blocks are the blocks which satisfy the archiving condition comprises:
recording the block data, the access frequency of which is higher than the preset access frequency in a preset period, and the corresponding height value;
matching the height values of the preset number of the blocks with the height value of the block data, the access frequency of which is higher than the preset access frequency;
when none of the height values of the preset number of the blocks matches the height value of the block data, the access frequency of which is higher than the preset access frequency, determining that the preset number of the blocks are the blocks which satisfy the archiving condition.

4. The method of claim 2, wherein detecting whether there is the block data which satisfies the archiving condition in the node of the blockchain comprises:
periodically detecting whether there is the block data which satisfies the archiving condition in the node of the blockchain, wherein a period of the detecting step is less than a time for generating the preset number of the blocks.

5. The method of claim 1, further comprising:
maintaining, in a database of the node of the blockchain, the archived file hash table, wherein the archived file hash table is adapted to save a corresponding relationship between the hash value of the archived compressed package file in the node of the blockchain and the height range of the blocks in the compressed package file.

6. The method of claim 1, further comprising:
when the compressed package file is not successfully uploaded to the reliable distributed storage system, outputting an error log and re-uploading the compressed package file to the reliable distributed storage system;
when the compressed package file is not successfully re-uploaded to the reliable distributed storage system, returning to the step that detecting whether there is the block data which satisfies the archiving condition in the node of the blockchain; and
deleting redundant data generated.

7. A method for querying block data of a blockchain, comprising:
acquiring a query request, wherein the query request comprises a height value of a block data to be queried;
when the block data to be queried is an archived block data, querying, in an archived file hash table, a hash value of a compressed package file corresponding to the height value, according to the height value, wherein the archived file hash table comprises a corresponding relationship between the hash value of the compressed package file of the archived block data and a height range of the blocks in the compressed package file;
when the hash value of the compressed package file corresponding to the height value is queried, determining, under a locally downloaded historical data directory, whether there is a folder named with the same hash value;
when the folder named with the same hash value is queried, accessing, under the historical data directory, the block data under the folder named with the same hash value for querying;
when the folder named with the same hash value is not queried, downloading the compressed package file corresponding to the hash value from a reliable distributed storage system, decompressing the compressed package file, and returning a query result.

8. The method of claim 7, wherein when the hash value of the compressed package file corresponding to the height value is not queried, the query request is forwarded to other nodes.

9. The method of claim 7, wherein after the query request is acquired, the method further comprises:
determining, according to whether the height value is less than the lowest height value of the blocks stored locally in the node of the blockchain, whether the block data to be queried has been archived.

10. A device for archiving block data of a blockchain, comprising a memory and a processor, wherein the processor executes the following steps:
detecting whether there is a block data which satisfies an archiving condition in a node of a blockchain, wherein the archiving condition comprises a height value of the block data and an access frequency of the block data;
when the block data which satisfies the archiving condition is detected, locally copying the block data which satisfies the archiving condition, compressing the block data to generate a compressed package file, and uploading the compressed package file to a reliable distributed storage system;
when the compressed package file is successfully uploaded to the reliable distributed storage system, acquiring a hash value of the compressed package file, and inserting the hash value of the compressed package file and a record of a height range of the blocks in the compressed package file into an archived file hash table.

11. The device of claim 10, wherein when executing the step of detecting whether there is the block data which satisfies the archiving condition in the node of the blockchain, the processor specifically executes the following steps:
checking a number of the blocks locally stored in the node of the blockchain;
when the number of the blocks locally stored is larger than a preset number, acquiring the preset number of the blocks from the block data with the lowest height value; and
when the access frequency of each of the preset number of the blocks is less than a preset access frequency, determining that the preset number of the blocks are the blocks which satisfy the archiving condition.

12. The device of claim 11, wherein when executing the step of when the access frequency of each of the preset number of the blocks is less than the preset access frequency, determining that the preset number of the blocks are the blocks which satisfy the archiving condition, the processor specifically executes the following steps:
recording the block data, the access frequency of which is higher than the preset access frequency in a preset period, and the corresponding height value ;
matching the height values of the preset number of the blocks with the height value of the block data, the access frequency of which is higher than the preset access frequency;
when none of the height values of the preset number of the blocks matches the height value of the block data, the access frequency of which is higher than the preset access frequency, determining that the preset number of the blocks are the blocks which satisfy the archiving condition.

13. The device of claim 10, wherein when executing the step of detecting whether there is the block data which satisfies the archiving condition in the node of the blockchain, the processor specifically executes the following steps:
periodically detecting whether there is the block data which satisfies the archiving condition in the node of the blockchain, wherein a period of the detecting step is less than a time for generating the preset number of the blocks.

14. The device of claim 10, wherein the processor further executes the following step:
maintaining, in a database of the node of the blockchain, the archived file hash table, wherein the archived file hash table is adapted to save a corresponding relationship between the hash value of the archived compressed package file in the node of the blockchain and the height range of the blocks in the compressed package file.

15. The device of claim 10, wherein the processor further executes the following steps:
when the compressed package file is not successfully uploaded to the reliable distributed storage system, outputting an error log and re-uploading the compressed package file to the reliable distributed storage system;
when the compressed package file is not successfully re-uploaded to the reliable distributed storage system, returning to the step that detecting whether there is the block data which satisfies the archiving condition in the node of the blockchain; and
deleting redundant data generated.

16. A device for querying block data of a blockchain, comprising a memory and a processor, wherein, the processor executes the following steps:
acquiring a query request, wherein the query request comprises a height value of a block data to be queried;
when the block data to be queried is an archived block data, querying, in an archived file hash table, a hash value of a compressed package file corresponding to the height value, according to the height value, wherein the archived file hash table comprises a corresponding relationship between the hash value of the compressed package file of the archived block data and a height range of the blocks in the compressed package file;
when the hash value of the compressed package file corresponding to the height value is queried, determining, under a locally downloaded historical data directory, whether there is a folder named with the same hash value;
when the folder named with the same hash value is queried, accessing, under the historical data directory, the block data under the folder named with the same hash value for querying;
when the folder named with the same hash value is not queried, downloading the compressed package file corresponding to the hash value from a reliable distributed storage system, decompressing the compressed package file, and returning a query result.

17. The device of claim 16, wherein when the hash value of the compressed package file corresponding to the height value is not queried, the query request is forwarded to other nodes.

18. The device of claim 16, wherein after the query request is acquired, wherein the processor further executes the following step:
determining, according to whether the height value is less than the lowest height value of the blocks stored locally in the node of the blockchain, whether the block data to be queried has been archived.
